(19) United States
(12) Patent Application Publication
(10) Pub. No.: US 2008/0056971 A1
(43) Pub. Date: Mar. 6, 2008

(54) System and process for treating gasification emission streams

(76) Inventor: Terry Hughes, Houston, TX (US)

Correspondence Address: TERRY HUGES, 16221 WALL STREET, JERSEY VILLAGE, TX, 77040, US

(21) Appl. No.: 11/512,987

(22) Filed: Aug. 30, 2006

(51) Int. Cl. B01D 53/40; C10J 3/00

(52) U.S. Cl. 423/220; 422/168; 48/61; 48/128

(57) ABSTRACT

The application is directed to an adaptable system for treating gasification emission streams that are generated during gasification operations, the system comprising a gasification zone configured to generate one or more gasification emission streams; a contact zone in fluid communication with the gasification zone configured to contact the gasification emission streams with one or more acid gas scavengers effective to remove acid gas and other emissions from the gasification emission streams, producing one or more disposal streams comprising the acid gas and other emissions; and a disposal zone in fluid communication with the contact zone configured to remove the disposal streams from the system; and processes for employing the system.

### FIELD OF THE APPLICATION

The application relates generally to treating fluid streams in gasification operations.

### BACKGROUND

Current gasification operating facilities can generate many undesirable emissions products. For example, gasification can generate fluid streams including large amounts of nitrogen oxides (NOx), sulfur oxides (SOx), carbon monoxide and various particulates that are often emitted into the atmosphere. Eliminating or abating these types of emissions during gasification often requires significant capital investment. This is due, in part, because current environmental permitting applications (for example, permitting applications in the United States) often require that emissions generated during startup, shutdown, and equipment failures be totaled with the normal operating continuous gasification emissions.

One known method of attempting to meet current environmental permitting requirements includes modifying facility startup procedures to reduce the time period that emission streams are allowed to flow. This method can be effective for lowering start up emissions, but is limited to process configurations and to mechanical limitations of the necessary equipment.

Another method includes constructing a start up absorber to trap acid gas and other emission products. However, the solvents used to trap acid gas from synthetic gas (“syngas”) require a low syngas and solvent temperature to work effectively. A low syngas temperature cannot be achieved without incorporating one or more low temperature gas cooling sections which significantly increases gasification costs.

In another method, start up fuels containing low amounts of acid gas have been used to reduce start up emissions from gasification facilities. However, this requires maintaining a separate inventory of start up fuel and additional handling equipment that adds significant costs. In addition, lowering the amount of acid gas in the start up fuel is only effective at lowering emissions upstream of acid gas recovery systems (“AGR”), and does not address post AGR emissions.

Another method involves using physical and chemical solvents to store emissions in a liquid form for later use or disposal. This method involves significant installation costs (including the installation of absorber towers, strippers, storage vessels, housing large volumes of solvent), uses high amounts of power to circulate the solvent, is limited by the properties of the solvents selected (pressure, temperature, circulation, contact time and saturation rates), requires large bulk storage of acid gas, and requires a compressor for absorbing from lower pressure streams.

An effective and less expensive technology is needed for meeting today's strict environmental permitting requirements in gasification operations.

### SUMMARY

The present application is directed to an adaptable system for treating gasification emission streams comprising acid gas that are generated during gasification operations, the system comprising a gasification zone configured to generate one or more gasification emission streams; a contact zone in fluid communication with the gasification zone configured to contact the gasification emission streams with one or more acid gas scavengers effective to remove acid gas and other emissions from the gasification emission streams, producing one or more disposal streams comprising the acid gas and other emissions; and a disposal zone in fluid communication with the contact zone configured to remove the disposal streams from the system; and processes for employing the system.

### BRIEF DESCRIPTION OF THE FIGURES

FIG. 1 illustrates a prior art gasification unit.

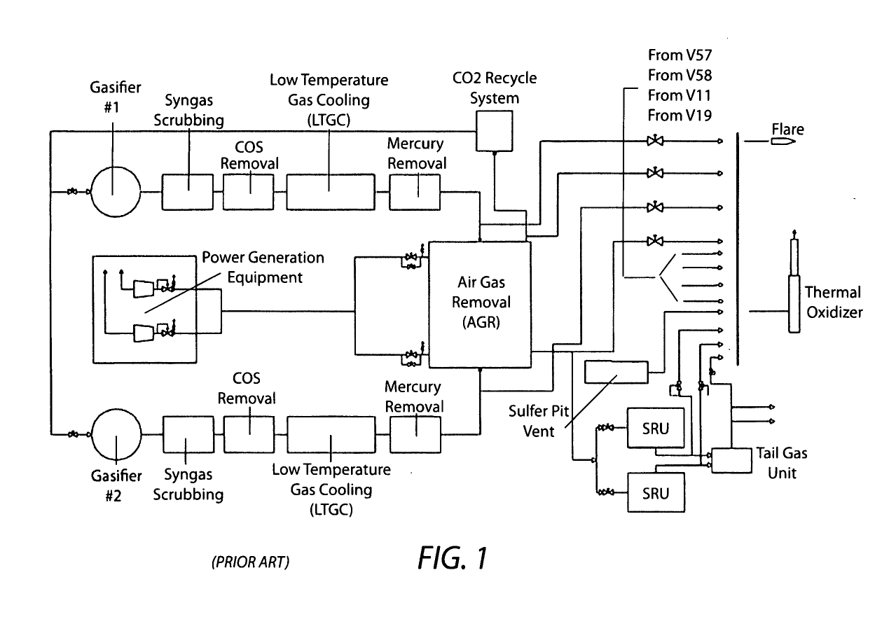

FIG. 2 illustrates a gasification operation including a vessel treatment integration into a multi-train gasification unit for treating intermittent gasification emission streams comprising acid gases associated with startup operations, shutdown operations, abnormal operations, equipment failures and trips.

FIG. 3 illustrates a gasification operation including a continuous injection treatment integration into a multi-train gasification stream post AGR for treating acid gases and other emissions products associated with continuous normal operations.

FIG. 4 illustrates a gasification operation including a vessel treatment integration into a multi-train gasification operation for treating acid gases and other emissions products associated with normal operations. FIG. 4 illustrates a bubble tower installation downstream of AGR wherein emissions levels are low enough to support continuous operation.

### BRIEF DESCRIPTION

The application is directed to an adaptable system for treating fluid streams that are generated during gasification operations and to processes for employing the system. Specifically, the application is directed to an adaptable system for treating gasification emission streams comprising one or more acid gases with one or more acid gas scavengers effective to remove acid gas and other emissions from the gasification emission streams and to processes for employing the system.

As used herein, the term “gasification”, “gasification operations” or “gasification process” refers to converting materials including low or negative-value carbon-based feedstocks such as coal, petroleum coke, and high sulfur fuel oil directly into gas, or synthesis gas (“syngas”). The phrase “gasification emission stream” refers to any fluid stream, including emission streams, found in or generated during gasification operations that typically comprises, but is not necessarily limited to CO, COS, CO₂, CS₂, H₂, entrained soot and ash, H₂S, S⁻², HS⁻, SO₂, H₂SO₄, NH3, HCl, HCN and combinations thereof. The terms “treat”, “treating”, “treatment” and the like refer to contacting one or more gasification emission streams with one or more acid gas scavengers. A “fluid” is any solid, liquid or gas flowable through conventional pipe or tubing in the gasification operation. An “acid gas” is typically described as any gas that can form acidic solutions when mixed with water, and frequently comprises but is not necessarily limited to the following: CO, COS, CO₂, CS₂, H₂S, S⁻², HS⁻, SO₂, H₂SO₄ and combinations thereof. An “oxidizing system” refers to systems including for example, gas turbines, chemical processes, flares, thermal oxidizers and power generation equipment used during the gasification operation. The term “emission” refers to one or more hazardous or non-hazardous environmental pollutants, including but not necessarily limited to those “emissions” as may be defined by Section 112 of the Clean Air Act as of the year 2006 A.D. The phrase “batch operation” refers to an intermittent system for treating batch fluid streams (e.g., batches of acid gas streams and other emission streams) generated during facility startup operations, facility shutdown operations, and during facility equipment failures. The phrase “continuous operation” refers to the treatment of constant type fluid streams generated during continuous normal gasification operations.

In one aspect, the present application provides a system for treating one or more gasification emission streams with one or more acid gas scavengers effective to reduce the acid gas concentration of the gasification emission streams and to processes employing the system.

In another aspect, the present application provides a system for treating one or more gasification emission streams with one or more acid gas scavengers effective to remove the acid gas from the gasification emission streams prior to release of the gasification emission stream into the atmosphere and to processes employing the system.

In another aspect, the application provides a system configured to treat one or more gasification emission streams with one or more acid gas scavengers prior to treating the gasification emission stream with an acid gas recovery (“AGR”) system and to processes employing the system.

In another aspect, the application provides a system configured to treat one or more gasification emission streams with one or more acid gas scavengers following treatment of the gasification emission stream with an AGR system and to processes employing the system.

In another aspect, the application provides a system for treating one or more gasification emission streams with one or more acid gas scavengers at a point upstream of any oxidizing system and to processes employing the system.

In still another aspect, the present application provides a system for treating one or more gasification emission streams with one or more acid gas scavengers effective to significantly reduce the amount of acid gas emissions generated during gasification start up operations and to processes employing the system.

In one particular aspect, the present application provides a system for treating one or more gasification emission streams associated with gasification equipment failures that can be diverted to one or more oxidizing systems, by treating the gasification emission streams with one or more acid gas scavengers upstream of any oxidizing system and to processes employing the system.

In another particular aspect, the present application provides a system for treating one or more gasification emission streams with one or more acid gas scavengers effective to maintain emission points of the gasification operation open for a duration necessary during gasification start up and shutdown operations to reduce potential equipment damage and personnel injury, and to processes employing the system.

In another aspect the present application provides a system for treating one or more gasification emission streams with one or more acid gas scavengers under powerless conditions including for example, when no electricity is applied to the system.

### Discussion of the System

In one aspect, the present system can be configured to compliment existing gasification operations to effectively treat one or more gasification emission streams with one or more acid gas scavengers to reduce or otherwise remove acid gas from the one or more gasification emission streams. In another aspect, the present system can be incorporated into the design of a new gasification operation. In addition, the present system can be configured to treat gasification emission streams comprising various concentrations of one or more acid gases. The present system can also be configured to substantially reduce the levels of acid gas emitted into the atmosphere following treatment of the gasification emission streams.

-The Gasification Zone

Suitably, the gasification zone of the present system comprises one or more of the following gasification operations: (1) stand alone gasification units, (2) multi-train gasification units, (3) Integrated Gasification Combined Cycle (“IGCC”) configurations with or without CO₂ recycle systems, (4) gasification for chemical or electrical energy production, (5) gasification systems with sulfuric acid plants or sulfur recovery units (SRU), (6) systems with or without tail gas treating units (“TGTU”), and (7) gasification systems using various AGR configurations. Typical AGR configurations include units that use, for example, one or more of the following: amine processes, the Selexol® process, and the Rectisol® process. In addition, each of the above gasification operations can be configured to initially treat gasification streams at various points in the system prior to treatment of the gasification stream at the contact zone.

-The Contact Zone

Suitably, the contact zone is in fluid communication with the gasification zone and comprises, for example, one or more contacting vessels and one or more injection ports, each configured to contact one or more gasification emission streams with one or more acid gas scavengers effective to remove the acid gas from the gasification emission streams. In another embodiment, the contact zone can comprise one or more circulating systems for contacting one or more gasification emission streams with one or more acid gas scavengers. According to the present system, each of the one or more contacting vessels, injection ports and circulating systems can be used in the system alone, or in combination.

In one embodiment, the contacting vessel includes, for example, a bubble tower in fluid communication with one or more gasification zones at a first end and in fluid communication with one or more disposal zones at a second end. Herein, the use of a contacting vessel in the system can be referred to as a vessel treatment. In another embodiment, the injection port is configured to contact one or more gasification emission streams with one or more acid gas scavengers by directing the acid gas scavenger into a flowline, pipeline, or gas gathering system of the gasification operation where the one or more gasification emission streams are present. Suitable injection ports include, for example, direct injection or spray nozzles, and column configurations containing flowable or liquid acid gas scavengers. Herein, the use of an injection port can be referred to as an injection treatment.

The vessel treatment can be used during either (1) a batch operation, or (2) a continuous operation. As previously discussed, a batch operation generates batches of gasification streams including for example, acid gas streams and other emissions products streams during facility startup operations, facility shutdown operations, and during facility equipment failures. In most instances, batch operations generate greater amounts of acid gases and other emissions products than do continuous operations. At a minimum, a contacting vessel comprising one or more acid gas scavengers is configured to remove acid gas and other emissions products from the gasification emission streams converting the gasification emission streams to one or more non-hazardous bio-degradable liquid streams that can be directed to one or more disposal zones.

In continuous operations incorporating a vessel treatment, one or more contacting vessels can be configured to receive from the gasification zone those continuous gasification emission streams that contribute to the facility continuous emissions total. Typically, continuous gasification emission streams generate fewer amounts of acid gases and other emissions products than generated during batch operations. This is due in part because continuous gasification emission streams of existing gasification operations are normally in fluid communication with other power producing equipment or chemical processes for treating gasification emission streams. At a minimum, a vessel treatment used in connection with continuous operations can be configured to remove acid gas and other emissions products from the gasification emission streams converting the gasification emission streams to one or more non-hazardous biodegradable disposal streams that can be directed to one or more disposal zones.

As with the vessel treatment, an injection treatment can be used during either (1) a batch operation, or (2) a continuous operation. In a batch operation wherein acid gas scavenger is injected into intermittent gasification emission streams, the acid gases and other emissions products in the gasification emission stream can be converted into non hazardous bio-degradable disposal streams captured and disposed of down stream of the injection point at one or more disposal zones.

In a continuous operation incorporating an injection treatment, a spray nozzle, for example, can be configured to inject one or more acid gas scavengers into continuous gasification emission streams. In an embodiment including a gasification emission stream comprising hydrogen sulfide, the acid gas scavenger can be injected into the gasification emission stream and react with hydrogen sulfide in the gasification emission stream converting the gasification emission stream to H₂O, which can then be removed from the system at one or more disposal zones. In another embodiment, injected acid gas scavenger can react with hydrogen sulfide in the gasification emission stream to produce elemental sulfur and spent acid gas scavenger. The elemental sulfur can be removed along with any spent acid gas scavenger at one or more disposal zones. In addition, the sulfur can be further separated from the spent acid gas scavenger and landfilled or added to the sulfur inventory in the SRU. The spent acid gas scavenger can also be regenerated using air or oxygen, and re-injected at the contact zone. In yet another embodiment, the injection treatment can be configured to inject acid gas scavenger into gasification emission streams associated with both continuous operations and batch operations. Herein, injection into gasification emission streams associated with continuous operations can be effective to reduce continuous emissions totals associated with normal operations. Furthermore, injection into gasification emission streams associated with batch operations can be effective to reduce short term emissions associated with startup, shutdown, equipment failures that affect yearly emission totals, which are in addition to continuous emission totals.

In both vessel treatments and injection treatments, one or more acid gas scavengers react with one or more acid gases in the gasification stream producing (1) one or more gas disposal streams, and (2) one or more liquid disposal streams—each of which is suitably directed to one or more disposal zones. Herein, the gas disposal stream can be defined as comprising any gas remaining in the gasification emission stream following either vessel and/or injection treatment. Suitably, the gas disposal stream is free of any acid gas and other emission products that were present in the gasification emission stream prior to treatment of the gasification emission stream with acid gas scavenger. The liquid disposal stream can be defined as comprising reaction products including one or more of the following: elemental sulfur, H₂O, organic compounds, biodegradable products and spent scavenger solution comprising, for example, organic liquids, elemental sulfur, metals, biodegradable products, sulfuric acid and zinc precipitate.

-The Disposal Zone

Suitably, the disposal zone is in fluid communication with at least the contact zone and comprises (1) a gas disposal zone wherein one or more gas disposal streams are emitted into the atmosphere using, for example, chemical processes, flares, and power generation equipment; and/or (2) a liquid disposal zone wherein one or more liquid disposal streams can be collected for removal, regeneration or destruction using for example, continuous blowdown units, tanks, screens and filters, regeneration units and one or more waste destruction technologies known to those skilled in the art.

In one embodiment of the system including a liquid disposal stream comprising spent scavenger and/or one or more bio-degradable organic products, a suitable liquid disposal zone includes, for example, (1) a landfill, (2) bio-treatment pond, and (3) the gasification zone itself wherein the stream can be injected back into the gasification zone via a grinding mill or direct injection where it can be thermally oxidized. In another embodiment of the system including a liquid disposal stream comprising elemental sulfur, a suitable disposal zone includes, for example, (1) a filtration system or unit, (2) a landfill, and (3) adding the elemental sulfur to the elemental sulfur produced in the SRU. In an embodiment of the system comprising any hazardous type reaction products, suitable disposal zones include for example, (1) the gasification zone used to incinerate the reaction products, and (2) conventional hazardous material disposal methods known to those skilled in the art including, for example, neutralizing the solution, metals treating, incineration, and containment in salt or waste sites.

In one particularly advantageous embodiment of the system including a gas disposal zone, the gas disposal zone comprises a flare system configured to burn off or otherwise emit one or more gas disposal streams into the atmosphere. In another particularly advantageous embodiment of the system including a liquid disposal zone configured to dispose of liquid disposal streams comprising sulfur, the sulfur can be filtered out of the stream and (1) added to the process inventory, or (2) landfilled. In still another particularly advantageous embodiment of the system including a liquid disposal zone configured to dispose of liquid disposal streams comprising one or more organic compounds and/or one or more bio-degradable products, the liquid disposal stream can be disposed of via methods known to those of ordinary skill in the art including for example, directing the stream to the gasification zone for destruction, and directing the stream to a bio-treating system.

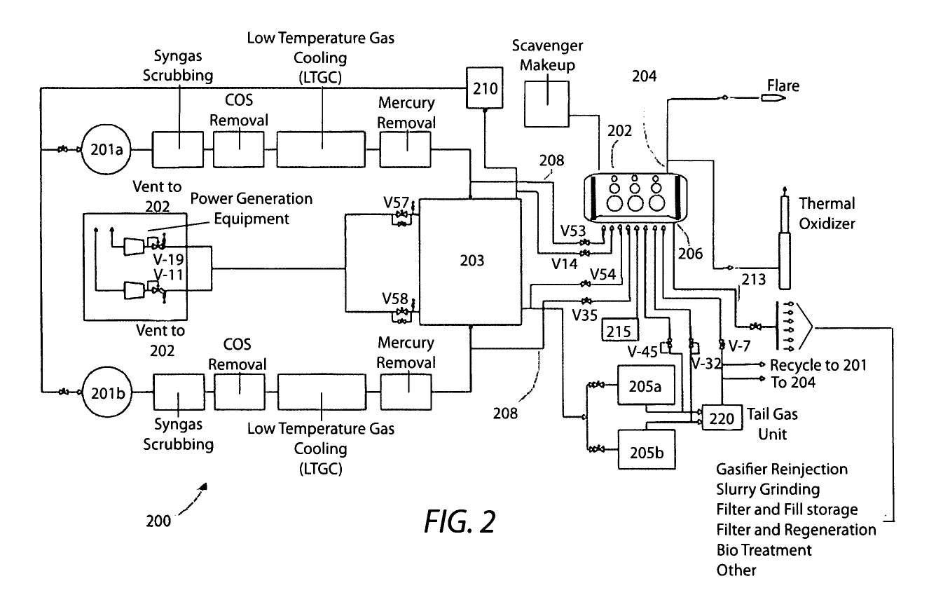

To better understand the novelty of the system and processes of use thereof, reference is hereafter made to the accompanying drawings. FIG. 2 shows an exemplary embodiment of a system comprising a vessel treatment 200 for a batch operation. The system includes a gasification zone 201 in fluid communication with an AGR 203, which is in fluid communication with a contact zone shown as contacting vessel, more particularly, bubble tower 202 and one or more SRU 205a, 205b, which are in fluid communication with one or more disposal zones including at least gas disposal zone 204 and liquid disposal zone 213. The system also includes a distribution header 206 located near the bottom of bubble tower 202 configured to receive one or more gasification emission streams 208 from the gasification zone 201.

Suitably, the bubble tower 202 can be configured to house a solution of one or more acid gas scavengers effective to remove or significantly reduce acid gas from gasification emission stream 208. In addition, the system can be configured so that the bubble tower 202, more specifically the distribution header 206, receives one or more gasification emission streams 208—each stream comprising various performance characteristics. For example, each of the gasification emission streams 208 can comprise varying temperatures, pressures, flow rates, load characteristics, varying amounts of liquids in the gasification emission streams, and varying acid gas concentrations. For exemplary purposes, one gasification emission stream may include a tail gas having a fairly low flow rate and a fairly low H₂S concentration from about 0.01% to about 5.0%. Another gasification emission stream may include a medium flow rate and very high H₂S levels exceeding 50% concentration. Still another gasification emission stream may have a high flow rate and include a relatively low concentration of H₂S from about 0.01% to about 5.0% concentration, along with other acid gases by volume. In sum, the system described herein can be configured to use any particular acid gas scavenger or combination of acid gas scavengers to treat one or more gasification emission streams having various performance characteristics including for example, various acid gas concentrations. In addition, the system can also be configured to adjust one or more performance characteristics prior to the gasification emission streams entering bubble tower 202.

The system of FIG. 2 requires minimal installation costs and is effective for start up, shutdown, abnormal operating conditions, equipment failures and plant trips. In addition, since acid gas scavenger is consumable, operations and maintenance expenses can be minimized by operating the vessel treatment only when necessary to meet or exceed regulatory permitting requirements. The system of FIG. 2 can also incorporate one or more contacting vessels wherein each contacting vessel can be configured to hold a different acid gas scavenger or combination of acid gas scavengers, or in the alternative, each contacting vessel can be configured to hold various concentrations of similar acid gas scavengers, wherein the contacting vessels can be positioned at various points along the system for contacting one or more gasification emission streams 208 as determined by the contents and the performance characteristics of each of the gasification emission streams 208.

The system of FIG. 2 can also be configured to treat gasification streams associated with facility shutdowns by allowing for de-pressurization of the gasification emission streams 208 through one or more of the bubble towers 202. Thus, each bubble tower 202 can be designed on a case-by-case basis according to the performance characteristics of particular gasification emission streams 208.

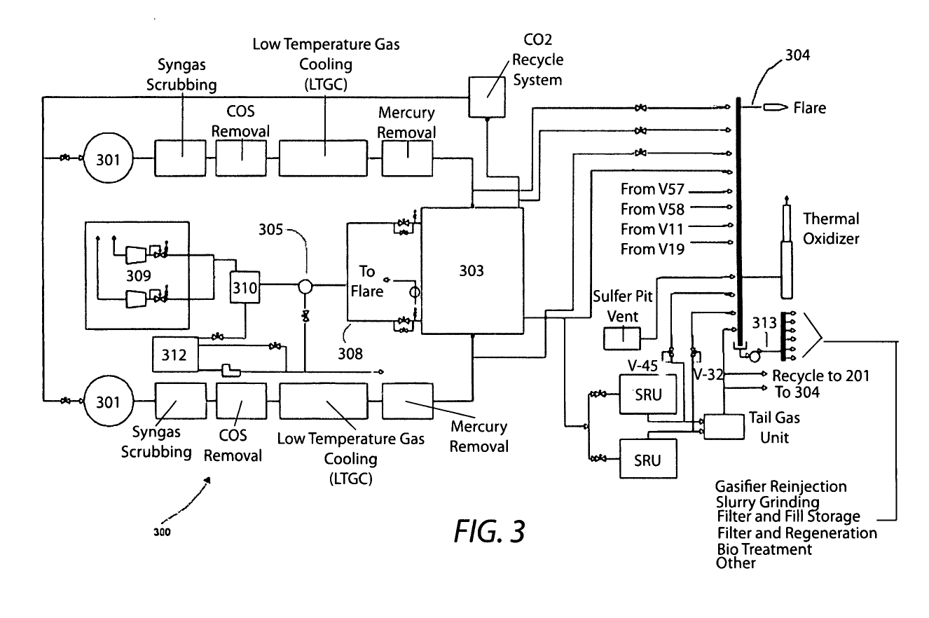

FIG. 3 shows an exemplary embodiment of a system comprising a continuous injection treatment 300 for use during continuous operations. The injection treatment 300 comprises a gasification zone 301 in fluid communication with an AGR 303 which is in fluid communication with one or more disposal zones including at least power generation equipment 309, gas disposal zone 304 and liquid disposal zone 313. The system further comprises a contact zone shown as injection nozzle 305 that is oriented along gasification emission stream 308 at a point between gasification zone 301 and power generation equipment 309. The injection nozzle 305 is configured to contact the gasification emission stream 308 with one or more acid gas scavengers. A knock out drum 310 can also be positioned downstream of injection nozzle 305 wherein the drum 310 is configured to recover any unspent acid gas scavenger and to keep any unspent acid gas scavenger from reaching other gasification process equipment in the system. In addition, the system suitably comprises a storage unit 312 which lies in fluid communication with injection nozzle 305 and is configured to house the fresh acid gas scavenger to be injected into the gasification emission stream 308 via injection nozzle 305.

Similar to vessel treatment 200, the injection nozzle 305 can be positioned at various points along each gasification emission stream 308 as determined by the acid gas scavengers used and the contents and performance characteristics of each gasification emission stream 308. In addition, the placement of the injection nozzles 305 can be determined by the retention time available to remove acid gas from the gasification emission stream 308, and the ability to adequately inject the acid gas scavenger into the gasification emission stream 308.

The above described vessel treatment 200 and injection treatment 300, can also be configured to treat gasification emission streams before or after treatment of the gasification stream with one or more gas/liquid separators or dehydration processes. In addition, each of treatments 200, 300 can be configured to treat gasification emission streams before or after AGR wherein the system is configured to remove acid gas and other emissions products prior to reaching one or more turbine exhaust stacks. Here, the system can be configured so that a smaller more cost effective AGR can be utilized upstream of the contact zone—compared to AGR units currently in use.

With known gasification operations, as the amount of acid gas being removed by an AGR unit increases, increased power is required due to greater circulation rates and steam consumption in providing the acid gas removal. Thus, the present system including a smaller/less effective AGR configuration can reduce power consumption during normal operations by lowering the AGR solvent circulation flow rates. Any acid gas not removed from the gasification emission streams by the smaller AGR unit, can then be removed at the contact zone using one or more acid gas scavengers.

For example, a current AGR configured to reduce the acid gas concentration in the gasification emission stream to about 20 ppm can consume about one or more mega watts (MW) of power at a construction cost of about U.S. $80,000,000 dollars—as of 2006 A.D. The present system, which is configured to reduce acid gas to about 300 ppm in the gasification stream, can incorporate a less effective AGR costing only about U.S. $50,000,000 to construct, and consume about 0.5 MW or less of power. Subsequently, the 300 ppm acid gas can be removed from the gasification emission stream at the contact zone to a concentration of about 1 ppm or less. Thus, the system of the present application can reduce construction costs by at least about 38% and power consumption by at least about 50%. Also, any costs associated with additional acid gas scavengers can be offset by the energy saved by incorporating the present system.

The present system can be further configured to include both a pressure and temperature drop for each gasification emission stream from the gasification zone to the contact zone. For vessel treatment 200, the gasification emission stream suitably comprises a pressure at the contact zone 202 up to about 2 bar (about 14.3 PSIG). For injection treatment 300, the gasification emission stream suitably comprises a pressure at the contact zone up to about 68 bar (about 1000 PSIG). A suitable temperature of the gasification emission stream at the contact zone for either vessel treatment 200 or injection treatment 300 can range from about 26° C. (about 80° F.) to about 65° C. (about 150° F.). In a particularly advantageous embodiment of the vessel treatment 200, the temperature and pressure of each gasification emission stream 208 is below the flash point of the acid gas scavenger used.

In an embodiment of the system where the gasification emission stream comprises syngas, the system can be configured so that the syngas stream can experience a temperature drop in the gasification zone and enter the contact zone at a temperature of from about 40.6° C. (about 105° F.) to about 43.3° C. (about 110° F.). Cooling units added to the system can further cool the syngas stream to an even lower temperature prior to entering the contact zone—depending on the type of acid gas scavenger used in the system. During winter or cold months, the cooling unit can even more efficiently reduce the temperature of gasification emission streams, lowering the temperature of a particular gasification emission stream entering the contact zone to about 26.7° C. (about 80° F.).

Syngas streams of typical gasification operations suitably comprise a pressure from about 2 bar to about 83 bar (from about 15 PSIG to about 1200 PSIG). In an embodiment of the system comprising a vessel treatment 200, the pressure of the syngas stream suitably decreases at bubble tower 202 to about 2 bar (about 14.3 PSIG). In a particularly advantageous embodiment of the system configured to treat syngas streams, the vessel treatment 200 comprises about a 42 bar (about 600 PSIG) letdown station wherein the bubble tower 202 comprises an outlet pressure about equal to the disposal zone pressure. Suitably, the resulting stream at disposal zone 204 comprises a pressure from about 1 bar (about 14.7 PSIA) to about 1.4 bar (about 5 PSIG).

In an embodiment of the system configured to treat liquid disposal streams comprising a spent scavenger solution including one or more biodegradable organic compounds, a continuous purge member can be added to the system to remove any heavy biodegradable product accumulating near the bottom of the contacting vessel. Fresh acid gas scavenger can be added to the contacting vessel to maintain a constant level of acid gas scavenger within the contacting vessel.

By incorporating the proper equipment sizing and proper amount of acid gas scavenger, the present system can be configured to treat gasification emission streams comprising any concentration of acid gas. For example, in an embodiment of the system configured to treat gasification emission streams comprising a total H₂S concentration of about 50%, the system is configured to treat the gasification emission stream with hydrogen sulfide scavengers or blends of scavengers to reduce the H₂S concentration of the treated gasification emission stream to about 0.01% or less. In a particularly advantageous embodiment, the system is configured to treat gasification streams comprising H₂S concentrations of any amount to reduce the H₂S concentration to about 1 ppm or less. In addition, local, state, and federal regulatory requirements can play a role in determining both the proper equipment sizing and amount of one or more acid gas scavengers necessary to treat particular acid gases in the one or more gasification emission streams.

### Discussion of the Process

The application is further directed to processes employing the above system for treating one or more gasification streams. Thus, in another embodiment, the process comprises providing an adaptable system for treating gasification emission streams comprising acid gas; treating the gasification emission streams in the system to remove one or more acid gases and other emissions from the gasification emission streams by contacting the gasification emission streams with one or more acid gas scavengers; producing one or more disposal streams comprising the acid gas and other emissions, and disposing of the one or more disposal streams.

In another embodiment, the process comprises (1) providing an adaptable system comprising a vessel treatment 200 including a gasification process 201 in fluid communication with a contacting vessel 202, which is in fluid communication with one or more disposal zones 204; (2) introducing one or more gasification emission streams 208 into the contacting vessel 202, which houses a predetermined volume of an acid gas scavenger solution; (3) contacting one or more gasification emission streams 208 with the acid gas scavenger solution, causing the acid gas to bubble up through the acid gas scavenger solution, or otherwise precipitate out from the gasification emission stream to form one or more disposal streams; and (4) disposing of the one or more disposal streams at disposal zone 204 and/or disposal zone 213.

In another embodiment, the process comprises (1) providing a system comprising an injection treatment 300 that includes a gasification process 301 in fluid communication with one or more disposal zones 304 and 313, an injection nozzle 305 oriented along the gasification emission stream 308 at a point between the gasification process 301 and one or more disposal zones 304, 313, wherein the injection nozzle 305 is configured to be inserted into the gasification emission stream 308, a knock out drum 310, configured to recover any unspent scavenger, positioned downstream from injection port 305 to keep the scavenger from reaching other gasification process equipment, and a storage unit 312 in fluid communication with injection nozzle 305 that is configured to house the acid gas scavenger to be inserted into the gasification emission stream 308; and (2) injecting one or more acid gas scavengers into the gasification emission stream 308 through injection nozzle 305 contacting the gasification emission stream 308 with the one or more acid gas scavengers; (3) forming one or more disposal streams; and (4) disposing of the one or more disposal streams at one or more disposal zones 304 and/or disposal zone 313.

In one aspect, the system and processes described herein are configured to eliminate operation shutdowns, which are normally performed for regulatory compliance purposes associated with equipment failures. In this instance, equipment failures can divert additional acid gas to one or more oxidizing systems increasing undesired emissions levels. Thus, the system and processes described herein, are effective to remove any additional acid gas before the acid gas can reach any oxidizing system at the disposal zone. For example, emissions can be eliminated during depressurization of the system by letting down the gasification emission stream through the bubble tower 202—as shown in FIG. 2. Typical equipment failures include, for example, sulfur recovery unit trips, tail gas treating unit trips, acid gas removal trips, recycle compressor trips, and combinations thereof. The inclusion of vessel treatment 200 and/or injection treatment 300 eliminates the need for fuel transfers (e.g. transferring from a high sulfur carbon fuel to a low sulfur carbon fuel during abnormal operation conditions or equipment failures), thus, eliminating or otherwise reducing emissions resulting from each of the above listed failures.

The processes described above, including the vessel treatment 200 and injection treatment 300, can be further characterized as wet removal processes. In one embodiment, the acid gas scavenger can react with the gasification emission stream in a gas phase to produce one or more disposal streams comprising for example, H₂O, hydrogen, organic compounds, biodegradable products, calcium carbonate and elemental sulfur. In another embodiment, the acid gas scavenger can react with the gasification emission stream in a liquid phase to produce one or more disposal streams comprising H₂O.

The acid gas scavengers described herein are effective to remove CO, COS, CO₂, CS₂, H₂, entrained soot and ash, H₂S, S⁻², HS⁻, SO₂, H₂SO₄, NH3, HCl, HCN and combinations thereof from a gasification emission stream to form one or more disposal streams that are nonhazardous and noncorrosive. Suitable acid gas scavenger materials include, for example, phosphonates, phosphate esters, mineral acids, chelants, organic blends, caustics, inorganic salts, polycarboxylates, copolymers, organic acids, and other polymers known to those skilled in the art. Particular acid gas scavengers comprise one or more of the following: amine based compounds such as triazines, monoethanolamine, diethanolamine, triethanolamine, methyldiethanolamine, alkyl polyamine, monomethylamine trizine, and either amine, inorganic salt based compounds such as sodium nitrite and sodium chlorite, alcohol/amine solutions, aldehydes including formaldehyde, amine/aldehyde condensate, liquid caustic soda, glyoxal, ethylene glycol, methanol, phosphate, phosphoric acid, hydroxyacetic acid, trisodium nitrilotriacetate, phosphonic acid, sodium tolyltriazole, diesel, potassium hydroxide, sulfamic acid, phosphate ester salt, sulfarnic acid, petroleum naphtha, trimethylbenzene, sodium tetrasulfide, butanol, ethanol, acrolein, water, polyamide, sodium nitrate, hydrochloric acid, ethylene glycol, tetrasodium EDTA, sodium hydroxide, phosphonate salt, isopropanol, polyphosphonate, hydrogen peroxide, citric acid, sulfuric acid, xylene, curnene, methylenephosphonic acid, polyol surfactant, ethylbenzene, zinc carboxylate salt, sodium hypochlorite, blends of zinc compounds, iron gluconate (powdered and granular), blends of inorganic zinc and sulfite, activated carbon, blends of phosphonated and alkyl phosphates, heavy aromatic solvents, iron sponge, catalysts and biocides. Commercial sources of suitable acid gas scavengers include Q² Technologies, LLC, located in Montgomery, Tex.; Champion Technologies, located in Houston, Tex.; and EnviroScrub Technologies Corporation, located in Minneapolis, Minn.

In one embodiment, the acid gas scavengers comprise a pH from about 3 to about 11. In a particularly advantageous embodiment, the acid gas scavengers comprise a pH from about 6 to about 11. Likewise, the acid gas scavengers described herein are effective to remove any calcium carbonate present in the gasification emission stream. In addition, the acid gas scavengers described herein are effective to treat gasification emission streams comprising temperatures less than the flash point for a given pressure. In other words, the acid gas scavengers described herein can be used to treat gasification emission streams at pressures and temperatures below the flash point of the acid gas scavenger. Thus, the system is effective to treat continuous gasification streams operating at elevated pressures.

For example, an acid gas scavenger comprising a boiling point of 149° C. (300° F.) at 600 psig, is effective to treat gasification emission streams at temperatures below 149° C. (300° F.) in systems operating at 600 psig. In another example, an acid gas scavenger comprising a boiling point of 100° C. (212° F.) at atmospheric pressures, is effective to treat gasification streams at temperatures below 100° C. (212° F.) in systems operating at 14.7 psia.

Suitably, the system is configured to operate at a temperature from about 26.6° C. (about 80° F.) to about 100° C. (212° F.). In a particularly advantageous embodiment, the system is configured to operate at a temperature of about 65.5° C. (about 150° F.). In addition, acid gas scavenger is suitably present in an amount effective to reduce the acid gas concentration of the treated gasification stream by about 100%.

The gasification emission streams described herein can further be defined as acidic, neutral or alkaline based, and can be oil soluble, water soluble, or soluble in both water and oil. Thus, particular acid gas scavengers or combinations of acid gas scavengers can be used in the present system and processes, as determined by the performance characteristics of the gasification emission streams present, and the efficiency of particular acid gas scavengers for particular acid gases comprising various performance characteristics.

In a suitable embodiment, from about 1.9 liters (about 0.5 gallons) to about 3.79 liters (about 1.0 gallons) of acid gas scavenger is required to treat from about 0.45 kg (about 1.0 lbs) to about 1.4 kg (about 3.0 lbs) of acid gas to effectively reduce the acid gas concentration of a gasification emission stream by about 99.0% or more. In a particularly advantageous embodiment, about 5.8 liters (about 1.5 gallons) of acid gas scavenger is required to treat about every 1.0 kg (about 2.2 lbs) of acid gas to reduce the acid gas concentration of a gasification emission stream by about 100%. Stated another way, about 2.6 liters (about 0.7 gallons) of acid gas scavenger is required to treat about every 0.45 kg (about 1.0 lbs) of acid gas to effectively reduce the acid gas concentration of a gasification emission stream by about 100%. In an embodiment including gasification emission streams comprising H₂S concentrations of about 60%, the system described herein will require about 180 kg/day (about 400 lbs/day) of acid gas scavenger to treat the H₂S gasification streams to effectively reduce the H₂S concentration of the gasification emission streams by about 100%.

In a particularly advantageous embodiment including vessel treatment 200, the volume of acid gas scavenger can be determined by the number of plant startups, trips and shutdowns encountered during an operating day. Thus, the present system is effective to transform gasification emission streams comprising acid gas and other emissions products produced during plant startups, trips and shutdowns into bio-degradable nonhazardous products. The more severe the emissions event, the more acid gas scavenger that can be consumed to prevent the emissions event from exceeding the allowable permitting levels for a gasification facility. For injection treatment 300, the load/rate and desired acid gas reduction ratio levels determine the amount of acid gas scavenger to be injected into any particular gasification emission stream.

In an embodiment incorporating a vessel treatment 200 configured to reduce SOx emissions from H₂S streams by about 100% during common startup operations, about 2.65 liters (about 0.7 gallons) of acid gas scavenger is effective to treat about 0.45 kg (about 1.0 lbs) of H₂S. In other words, about 5300 liters (about 1,400 gallons) of acid gas scavenger is consumed for about every 907 kg (about 2000 lbs) of SOx from H₂S streams.

In another embodiment incorporating a vessel treatment 200 configured to reduce SOx emissions by about 100% during startup operations, shutdown operations, or equipment trips, about 3.79 liters (about 1.0 gallons) of acid gas scavenger is effective to treat about 1.4 kg (about 3.0 lbs) of H₂S. In other words, about 2525 liters (about 667 gallons) of acid gas scavenger is consumed for about every 907 kg (about 2000 lbs) of SOx from H₂S streams.

The embodiments described above will be better understood with reference to the following non-limiting examples, which are illustrative only and not intended to limit the present application to a particular embodiment.

### EXAMPLE 1

In a first non-limiting example, a H₂S stream generated during gasification operations is treated with a H₂S scavenger by fitting the gasification facility with a vessel treatment 200—as shown in FIG. 2. In this example, the bubble tower 202 is configured to hold about 3,785 liters (about 1000 gallons) of H₂S scavenger effective to treat a H₂S stream having a H₂S concentration at bubble tower 202 from about 5% to about 60%. The H₂S scavenger is comprised of a proprietary technology (a multichelate iron catalyst herein represented as “R”), marketed under the trade name LO-CAT® and owned by Gas Technology Products, LLC, Houston, Tex. In this example, the H₂S stream is reacted with the proprietary H₂S scavenger in a liquid phase, converting H₂S to elemental sulfur. The overall LO-CAT® reaction is as follows:

H₂S+RO₂ [symbol] H₂O+S

The proprietary LO-CAT® reactions produce the following products:

### Absorption Section

H₂S(gas)+H₂O(aq) [symbol] H₂S(aq)+H₂O(aq)

H₂S(aq) [symbol] HS⁻(aq)+H⁺(aq)

HS⁻(aq)+2Fe⁺⁺⁺(aq)→S_{(solid)}+2Fe⁺⁺(aq)+H⁺(aq)

### Regeneration Section

RO₂(gas)+H₂O(aq) [symbol] RO₂(aq)+H₂O(aq)

RO₂(aq)+H₂O(aq)+Fe++(aq)→2OH⁻+H⁺(aq)+Fe⁺⁺⁺

In sum, elemental sulfur and water is formed within the H₂S scavenger solution from the reaction between the H₂S in the H₂S stream and the H₂S scavenger solution. The elemental sulfur settles to the bottom of the solution and is filtered from the solution and either disposed of at a landfill, added to sulfur production inventory from the sulfur recovery unit (SRU) or sold as a by-product. The water generated in the reaction remains in the solution and is consumed in the regeneration phase of the circulating scavenger solution. About 100% of the H₂S content is removed from the H₂S stream at bubble tower 202. The resulting stream, which is free of H₂S, is directed to one or more disposal zones 204 comprising, for example, power generation equipment, chemical processes or incineration.

### EXAMPLE 2

In a second non-limiting example including a system configured to treat Syngas streams generated during batch operations, the following steps are employed using the vessel treatment shown in FIG. 2:

(a) During startup of gasifiers 201a and 201b, vents V-53 and V-35 are opened for a short time wherein Syngas streams are treated at bubble tower 202 before being directed to flare 204.

(b) Vent V-54 is opened during startup of gasifiers 201a and 201b until H₂S and other acid gas can be directed to one or more SRU units 205a and 205b. Vent V-54 can also be opened during any SRU unit 205a and 205b trips. Following SRU treatment, the streams are directed to bubble tower 202.

(c) Vent V-14 is optional depending on whether a CO₂ recycle compressor is present in the configuration. Vent V-14 is opened during startup and when the CO₂ recycle compressor 210 trips, directing CO₂ and H₂S to bubble tower 202.

(d) Vent V-7 is opened during SRU/acid plant startup and when the CO₂ recycle compressor 210 trips. As V-7 opens, H₂S is removed at bubble tower 202.

(e) Vents V-45 and V-32 are opened during SRU/acid plant startup and tail gas unit (TGU) 220 trips, directing any excess H₂S is from SRU 205a, 205b to bubble tower 202 prior to reaching disposal zone 204.

(f) Vents V-19 and V-11 are configured to direct clean Syngas streams directly to disposal zone 204. As shown in FIG. 2, the Syngas streams are directed to bubble tower 202 wherein H₂S and other acid gases are removed from the Syngas streams prior to the Syngas streams reaching disposal zone 204. The Syngas streams venting through V-19 and V-11 comprise from about 20 to about 300 ppm H₂S prior to being treated at bubble tower 202.

(g) Clean Syngas vents to the atmosphere via vents V-57 and V-58, as pressure in the system is being established and as the AGR 203 is being adjusted to work correctly during startup. As shown in FIG. 2, vents V-57 and V-58 direct Syngas streams to bubble tower 202 to remove H₂S and other acid gases from the Syngas streams prior to entering the atmosphere at disposal zone 204. The streams vented through valves V-57 and V-58 comprise from about 10 ppm to about 20 ppm H₂S prior to being treated at bubble tower 202.

(h) The sulfur pit vent 215 can be a major contributor to yearly emission totals for a gasification facility. These emissions can be removed by venting the sulfur pit stream to the bubble tower 202. This can significantly reduce sulfur emission totals.

### EXAMPLE 3

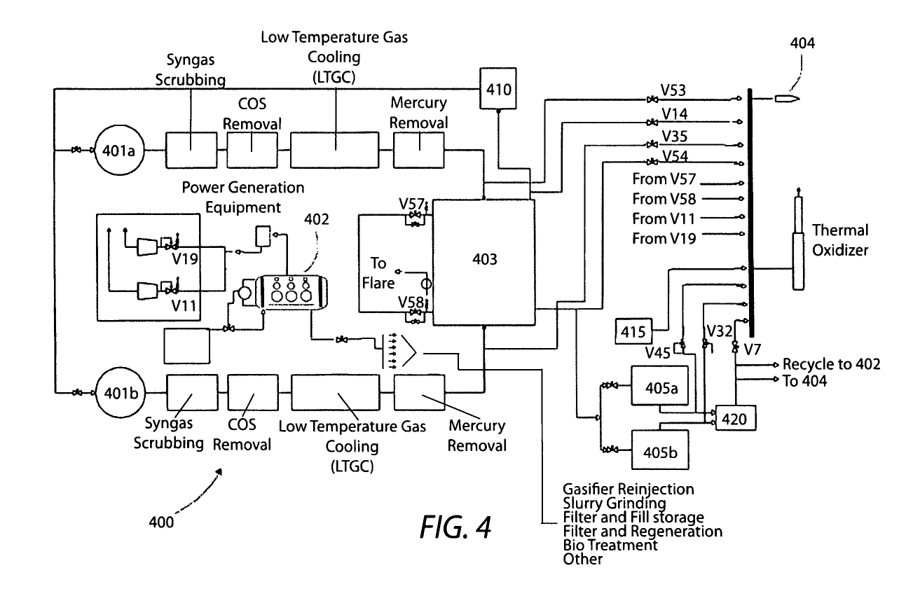

In a third non-limiting example of a continuous emission reduction gasification system comprising a vessel treatment 400 as shown in FIG. 4, the system comprises at least (1) two gasifiers, (2) a Syngas scrubber, (3) a COS removal system, (4) a Syngas cooling section, (5) a mercury removal unit, (6) a CO₂ recycle system, (7) an AGR system, and (8) a H₂S scavenging bubble tower 402 integrated into the system.

During startup of known continuous emission gasification systems, Syngas is vented at various points along the system to the atmosphere at disposal zone 404 (e.g., flares, thermal oxidizers or power generation equipment). The venting point of the Syngas stream along the system determines the concentration of H₂S at disposal zone 404. Concentrated H₂S streams can comprise up to about 60% H₂S at disposal zone 404. The system of this example, including bubble tower 402 removes H₂S from the Syngas stream to below 1 ppm prior to the Syngas stream reaching disposal zone 404.

Details of the vessel treatment 400 are listed below:

(1) Bubble tower 402 is filled with approximately 3785 liters of H₂S scavenger.

(2) At the gasification zone, each gasifier 401a and 401b partially oxidizes carbon based fuels when combined with oxygen at high temperatures to produce an initial synthetic gaseous fuel (Syngas) containing various acid gases including sulfur species acid gases such as H₂S.

(3) The Syngas is directed to a Syngas scrubbing unit where the Syngas is scrubbed of particulate matter.

(4) The Syngas is directed to a COS removal unit, which removes the majority of COS from the Syngas stream by converting the COS into additional H₂S.

(5) The Syngas stream is then cooled, readying the Syngas stream for the AGR 403 process where H₂S is separated from the Syngas stream. The cooled Syngas stream comprises from about 2,268 kg to about 6,800 kg H₂S (from about 5000 to about 15,000 lbs) at a concentration of about 10% H₂S as the stream enters the AGR 403.

(6) Trace amounts of mercury can also be removed from the Syngas stream prior to reaching the AGR 403.

(7) The concentration of H₂S in the Syngas stream entering the AGR 403 is up to about 10%. The concentration of H₂S in the Syngas is directly proportional to the sulfur species contained within the coal or carbon fuel being gasified.

(8) The AGR 403 produces clean Syngas, which is directed to the power generation equipment or chemical production systems. Small amounts of H₂S remain in the clean Syngas stream, and the system is configured so that the stream can flow through bubble tower 402. The clean Syngas stream comprises from about 20 ppm to about 300 ppm H₂S as the Syngas stream exits AGR 403 and enters bubble tower 402.

(9) The AGR 403 is further configured to direct streams comprising H₂S and CO₂ back to gasification zone 401a and 401b via CO₂ recycle system 410. During recycle malfunctions, streams can be vented to an additional bubble tower 202, as shown in FIG. 2, for removing H₂S.

(10) The Syngas stream is treated at bubble tower 402 producing one or more disposal streams. The disposal streams are captured for further storage, treatment, or disposal. The sulfur free Syngas stream exiting bubble tower 402 is directed to power generating equipment, chemical processes or other oxidizers including flare 404. Bubble tower 402 also produces reaction products that are removed through the liquid disposal zone. The liquid disposal stream comprises at least organic compounds and biodegradable liquids, which are disposed of either through conventional methods known to those of ordinary skill in the art, recycled back to gasification zones 401a and 401b, or directed to a bio-treatment system.

A known gasification facility can continuously emit about 20 ppm of SOx emissions under normal operating conditions. The systems of Examples 1-3 are effective to reduce SOx emissions (H₂S based SOx emissions) to less than about 1 ppm. The system of Example 2 is effective to reduce emissions to less than about 1 ppm SOx (H₂S based SOx emissions). The acid gas scavenger treatment of the present system is effective to produce SOx free emission streams regardless of the mode of SOx generation.

Persons of ordinary skill in the art will recognize that many modifications may be made to the present application without departing from the spirit and scope of the application. The embodiment(s) described herein are meant to be illustrative only and should not be taken as limiting the invention, which is defined in the claims.

I claim:

1. An adaptable system for treating a gasification emission stream comprising acid gas and other emissions, comprising:
a gasification zone configured to generate one or more gasification emission streams;
a contact zone in fluid communication with the gasification zone configured to contact the gasification emission streams with one or more acid gas scavengers effective to remove acid gas and other emissions from the gasification emission streams producing one or more disposal streams comprising the acid gas and other emissions; and
a disposal zone in fluid communication with the contact zone configured to remove the disposal streams from the system.

2. The system of claim 1, wherein the gasification zone includes one or more of the following gasification operations: stand alone gasification units, multi-train gasification units, Integrated Gasification Combined Cycle configurations with C0₂ recycle systems, Integrated Gasification Combined Cycle configurations without C0₂ recycle systems, gasification for chemical or electrical energy production, gasification systems with sulfuric acid plants or sulfur recovery units, systems with or without tail gas treating units, gasification systems using various acid gas recovery configurations, and combinations thereof.

3. The system of claim 1, wherein the contact zone comprises a contacting vessel comprising one or more acid gas scavengers.

4. The system of claim 3, wherein said contacting vessel comprises a bubble tower.

5. The system of claim 1, wherein the contact zone comprises an injection port.

6. The system of claim 5, wherein the injection port comprises one or more of the following: direct injection, spray nozzles, and column configurations containing acid gas scavengers.

7. The system of claim 1, wherein said disposal zone comprises a gas disposal zone.

8. The system of claim 1, wherein said disposal zone comprises a liquid disposal zone.

9. The system of claim 1, wherein the acid gas scavengers comprise one or more of the following components: phosphonates, phosphate esters, mineral acids, chelants, organic blends, caustics, inorganic salts, polycarboxylates, copolymers, and organic acids.

10. The system of claim 1, wherein the acid gas scavengers comprise one or more of the following components:
amine based compounds such as triazines, monoethanolamine, diethanolamine, triethanolamine, methyldiethanolamine, alkyl polyamine, monomethylamine trizine, and either amine, inorganic salt based compounds such as sodium nitrite and sodium chlorite, alcohol/amine solutions, aldehydes including formaldehyde, amine/aldehyde condensate, liquid caustic soda, glyoxal, ethylene glycol, methanol, phosphate, phosphoric acid, hydroxyacetic acid, trisodium nitrilotriacetate, phosphonic acid, sodium tolyltriazole, diesel, potassium hydroxide, sulfamic acid, phosphate ester salt, sulfarnic acid, petroleum naphtha, trimethylbenzene, sodium tetrasulfide, butanol, ethanol, acrolein, water, polyamide, sodium nitrate, hydrochloric acid, ethylene glycol, tetrasodium EDTA, sodium hydroxide, phosphonate salt, isopropanol, polyphosphonate, hydrogen peroxide, citric acid, sulfuric acid, xylene, curnene, methylenephosphonic acid, polyol surfactant, ethylbenzene, zinc carboxylate salt, sodium hypochlorite, blends of zinc compounds, iron gluconate (powdered and granular), blends of inorganic zinc and sulfite, activated carbon, blends of phosphonated and alkyl phosphates, heavy aromatic solvents, iron sponge, catalysts and biocides.

11. The system of claim 1, wherein the gasification emission stream comprises one or more of the following components: CO, COS, CO₂, CS₂, H₂, entrained soot and ash, H₂S, S⁻², HS⁻, SO₂, H₂SO₄, NH3, HCl and HCN.

12. The system of claim 1, wherein the system is configured to operate at a temperature from about 26.6° C. to about 100° C.

13. The system of claim 1, wherein the acid gas scavengers comprise a pH from about 3 to about 11.

14. The system of claim 1, wherein acid gas scavengers comprising a boiling point of 100° C. at atmospheric pressures are effective to treat gasification emission streams at temperatures below 100° C. when the system operates at 14.7 psia.

15. The system of claim 1, wherein the system is configured to treat one or more gasification emission streams with one or more acid gas scavengers following treatment of the gasification stream with an acid gas recovery system.

16. The system of claim 1, wherein disposal streams comprising spent scavenger and bio-degradable organic products are removed from the system using one or more of the following: a landfill, a bio-treatment pond, and the gasification zone.

17. The system of claim 1, wherein disposal streams comprising elemental sulfur are removed from the system using one or more of the following: filtration, a landfill, and adding the elemental sulfur removed from the liquid disposal stream to the elemental sulfur produced in the sulfur recovery unit.

18. The system of claim 1, wherein the disposal stream comprises reaction products comprising one or more of the following components: elemental sulfur, H₂O, organic compounds, bio-degradable products and spent scavenger solution comprising organic liquids, elemental sulfur, metals, biodegradable products, sulfuric acid and zinc precipitate.

19. The system of claim 1, wherein acid gas is removed from the gasification emission streams under powerless conditions.

20. The system of claim 1, wherein the system is further configured to operate only when necessary to meet or exceed regulatory permitting requirements.

21. The system of claim 1, wherein the system is configured to lower the AGR solvent circulation flow rates by including a smaller/less effective AGR configuration.

22. A process for treating one or more gasification emission streams comprising acid gas, comprising the steps of:
providing an adaptable system for treating gasification emission streams comprising acid gas;
treating gasification emission streams in the system to remove one or more acid gases and other emissions from the gasification emission streams by contacting said gasification emission streams with one or more acid gas scavengers;
producing one or more disposal streams comprising the acid gas and other emissions; and
removing the disposal streams from the system.

23. The process according to claim 22, wherein said contact between the gasification emission stream and one or more acid gas scavengers is employed using a vessel treatment.

24. The process according to claim 22, wherein said contact between the gasification emission stream and one or more acid gas scavengers is employed using an injection treatment.

25. The process according to claim 22, wherein said contact between the gasification emission stream and one or more acid gas scavengers is employed using both a vessel treatment and an injection treatment.

26. The process according to claim 22, wherein the temperature and pressure of each gasification emission stream is below the flash point of the acid gas scavenger used in the process.

27. The process according to claim 22, wherein the gasification emission stream to be treated comprises one or more of the following components: CO, COS, CO₂, CS₂, H₂, entrained soot and ash, H₂S, S⁻², HS⁻, SO₂, H₂SO₄, NH3, HCl, HCN.

28. The process according to claim 22, wherein the acid gas scavengers comprise one or more of the following components:
amine based compounds such as triazines, monoethanolamine, diethanolamine, triethanolamine, methyldiethanolamine, alkyl polyamine, monomethylamine trizine, and either amine, inorganic salt based compounds such as sodium nitrite and sodium chlorite, alcohol/amine solutions, aldehydes including formaldehyde, amine/aldehyde condensate, liquid caustic soda, glyoxal, ethylene glycol, methanol, phosphate, phosphoric acid, hydroxyacetic acid, trisodium nitrilotriacetate, phosphonic acid, sodium tolyltriazole, diesel, potassium hydroxide, sulfamic acid, phosphate ester salt, sulfarnic acid, petroleum naphtha, trimethylbenzene, sodium tetrasulfide, butanol, ethanol, acrolein, water, polyamide, sodium nitrate, hydrochloric acid, ethylene glycol, tetrasodium EDTA, sodium hydroxide, phosphonate salt, isopropanol, polyphosphonate, hydrogen peroxide, citric acid, sulfuric acid, xylene, curnene, methylenephosphonic acid, polyol surfactant, ethylbenzene, zinc carboxylate salt, sodium hypochlorite, blends of zinc compounds, iron gluconate (powdered and granular), blends of inorganic zinc and sulfite, activated carbon, blends of phosphonated and alkyl phosphates, heavy aromatic solvents, iron sponge, catalysts and biocides.

29. The process according to claim 22, wherein the acid gas reacts with the acid gas scavengers to form one or more of the following components: elemental sulfur, H₂O, organic compounds, biodegradable products and spent scavenger solution comprising organic liquids, elemental sulfur, metals, biodegradable products, sulfuric acid and zinc precipitate.

30. The process according to claim 22, wherein the acid gas scavenger reacts with the gasification emission stream in a liquid phase to produce one or more disposal streams comprising H₂O.

31. The process according to claim 22, wherein said treatment of the gasification streams occurs post acid gas recovery.

32. The process according to claim 22, wherein the disposal streams are removed from the system using an oxidizing system.

33. The process according to claim 22, wherein about 5.8 liters of acid gas scavenger is used to treat about every 1.0 kg of acid gas to reduce the acid gas concentration of a treated gasification stream by about 100%.

34. The process according to claim 27, wherein about 2.65 liters of acid gas scavenger is effective to treat about 0.45 kg of H₂S.

35. A process for removing acid gas from a gasification emission stream generated during gasification facility startup operations, facility shutdown operations, and facility equipment failures, the process comprising:
providing an adaptable system for treating the gasification emission stream;
treating the gasification emission stream in the system to remove one or more acid gases and other emissions from the gasification emission stream by contacting the gasification emission stream with one or more acid gas scavengers;
producing one or more disposal streams comprising the acid gas and other emissions; and
removing said disposal streams from the system;
wherein said process is effective to reduce the amount of acid gas in the treated gasification emission stream to about 0.01% or less.

36. The process according to claim 35, wherein said contact between the gasification stream and one or more acid gas scavengers is employed using a vessel treatment.

37. The process according to claim 35, wherein said contact between the gasification stream and one or more acid gas scavengers is employed using an injection treatment.

38. The process according to claim 35, wherein the acid gas scavengers comprise one or more of the following components:
amine based compounds such as triazines, monoethanolamine, diethanolamine, triethanolamine, methyldiethanolamine, alkyl polyamine, monomethylamine trizine, and either amine, inorganic salt based compounds such as sodium nitrite and sodium chlorite, alcohol/amine solutions, aldehydes including formaldehyde, amine/aldehyde condensate, liquid caustic soda, glyoxal, ethylene glycol, methanol, phosphate, phosphoric acid, hydroxyacetic acid, trisodium nitrilotriacetate, phosphonic acid, sodium tolyltriazole, diesel, potassium hydroxide, sulfamic acid, phosphate ester salt, sulfarnic acid, petroleum naphtha, trimethylbenzene, sodium tetrasulfide, butanol, ethanol, acrolein, water, polyamide, sodium nitrate, hydrochloric acid, ethylene glycol, tetrasodium EDTA, sodium hydroxide, phosphonate salt, isopropanol, polyphosphonate, hydrogen peroxide, citric acid, sulfuric acid, xylene, curnene, methylenephosphonic acid, polyol surfactant, ethylbenzene, zinc carboxylate salt, sodium hypochlorite, blends of zinc compounds, iron gluconate (powdered and granular), blends of inorganic zinc and sulfite, activated carbon, blends of phosphonated and alkyl phosphates, heavy aromatic solvents, iron sponge, catalysts and biocides.

39. The process according to claim 35, wherein the system can be adapted to use any particular acid gas scavenger or combination of acid gas scavengers to treat one or more gasification emission streams comprising specific acid gas concentrations and specific performance characteristics.

40. The process according to claim 36, wherein the vessel treatment is operated only when necessary to meet or exceed regulatory permitting requirements.
